(19) United States
(12) Patent Application Publication
(10) Pub. No.: US 2013/0120932 A1
(43) Pub. Date: May 16, 2013

(54) MOTHERBOARD WITH HEAT SINK

(71) Applicants: LIANG TAN, Shenzhen City (CN); XIAO-FENG MA, Shenzhen City (CN)

(72) Inventors: LIANG TAN, Shenzhen City (CN); XIAO-FENG MA, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/304,390

(22) Filed: Nov. 24, 2011

(30) Foreign Application Priority Data
Nov. 16, 2011 (CN) 201110363424.0

(51) Int. Cl. G06F 1/20

(52) U.S. Cl. 361/679.54

(57) ABSTRACT

A motherboard includes a heat sink, a circuit board forming an electronic element and two latches at opposite sides of the electronic element, and two fixing members. The heat sink includes a base board and a number of rows of spaced fins. Two lows of protrusions are formed on the base board and are respectively located at opposite sides of a row of fins. Each protrusion defines a through hole. Each fixing member includes a clamping portion engaging with one of the latching members, and two engaging portions engaging in the corresponding through holes.

### BACKGROUND

1. Technical Field

The present disclosure relates to a motherboard having a heat sink.

2. Description of Related Art

Heat sinks are often secured to circuit boards with screws or buckles, for cooling electronic components. However, using the screws is time-consuming, while using the buckles is complicated and costly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a motherboard including a heat sink.

FIG. 2 is an enlarged of the heat sink of FIG. 1, but shown in different perspective.

FIG. 3 is an assembled, isometric view of the motherboard of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

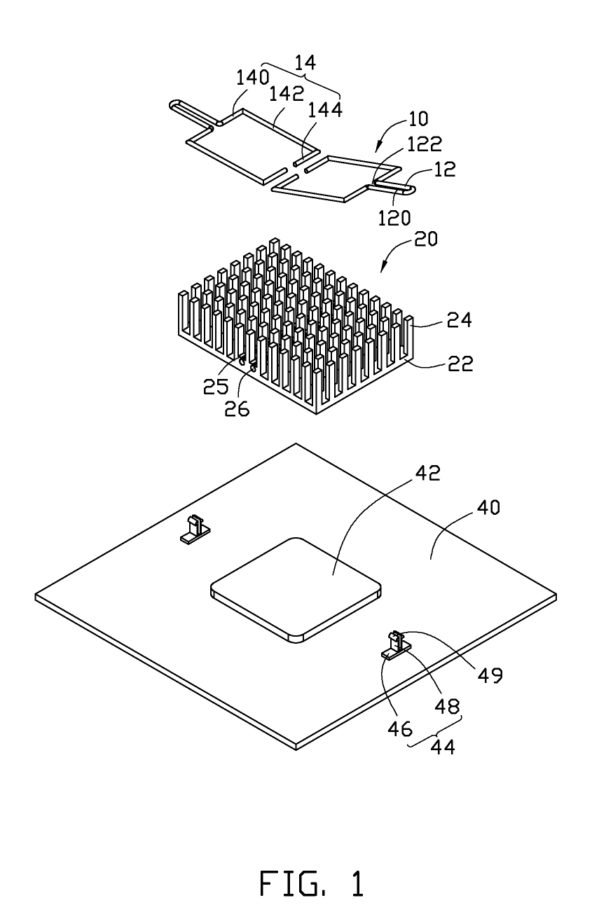

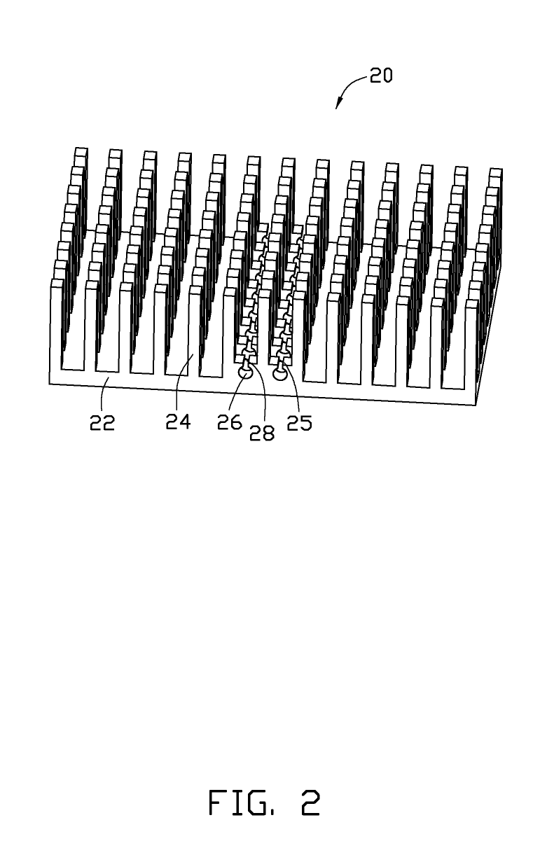

Referring to FIGS. 1 and 2, an exemplary embodiment of a motherboard includes a heat sink 20, a circuit board 40, and two fixing members 10.

The heat sink 20 includes a base board 22 and a plurality of fins 24 aligned in rows, perpendicularly extending up from the base board 22. The fins 24 of each row are arranged apart. Two rows of spaced protrusions 25 are formed on the base board 22, at opposite sides of a row of fins 24. Each protrusion 25 defines a through hole 26 aligned with each row of protrusions 25. A small opening 28 is defined in a top of each protrusion 25, communicating with the corresponding through hole 26.

The circuit board 40 includes an electronic element 42, such as a central processing unit, and two latches 44 mounted on the circuit board 40 and positioned at opposite sides of the electronic element 42. Each latch 44 includes a plate 46 fixed on the circuit board 40 and two opposite hooks 48 perpendicularly extending up from the plate 46. A projection 49 protrudes from a top of an outer surface of each hook 48.

Each fixing member 10 is made of a deformable metal pole. Each fixing member 10 includes a substantially U-shaped clamping portion 12 defining an open-ended slot 120 and two substantially U-shaped engaging portions 14 symmetrically extending from opposite ends of the clamping portion 12 at the opening 122 of the slot 120. Each engaging portion 14 includes an extension portion 140 perpendicularly extending out from a corresponding end of the clamping portion 12, a connection portion 142 perpendicularly extending from a distal end of the extension portion 140 away from the clamping portion 12, and a pin 144 perpendicularly extending inward from a distal end of the connection portion 142 toward the other engaging portion 14.

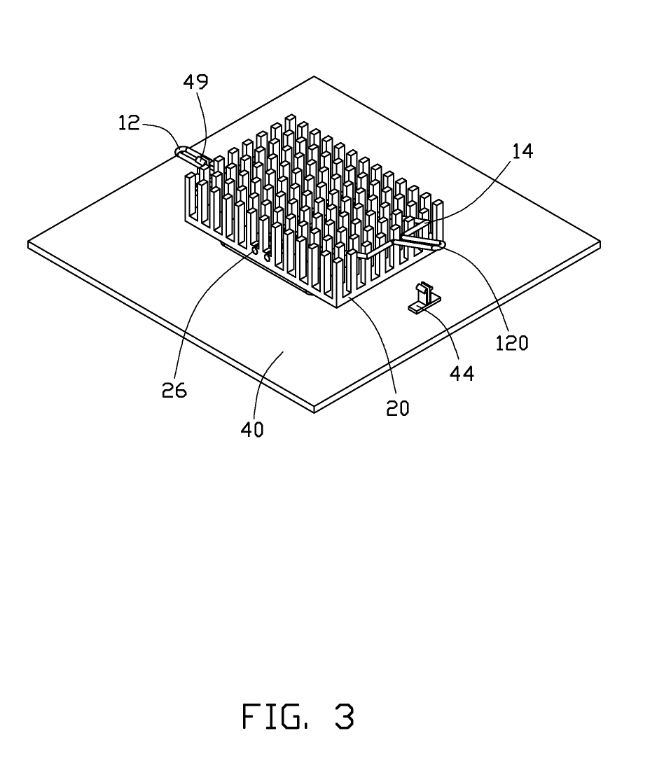

Referring to FIG. 3, in assembly, the pins 144 of each fixing member 10 are inserted into two through holes 26 through the corresponding openings 28. The clamping portion is located outside the fins 24.

In use, the heat sink 20 is attached to the electronic element 42. The clamping portions 12 are deformed down, until the hooks 48 of each latch 40 are extended through the corresponding slot 120. The projections 49 are blocked by the clamping portions 12. The connection portions 142 lie on the base board 22 and are respectively sandwiched between some corresponding fins 24.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A motherboard, comprising:
a circuit board comprising an electronic element and a latch positioned at a side of the electronic element;
a heat sink comprising a base board attached to the electronic element, a plurality of rows of spaced fins extending up from the base board, and a row of protrusions formed on the base board and positioned at a side of a row of fins, each protrusion defining a through hole; and
a fixing member comprising a clamping portion engaging with the latch and two engaging portions engaging in the through holes.

2. The motherboard of claim 1, wherein the clamping portion is substantially U-shaped to clamp the latch.

3. The motherboard of claim 2, wherein the latch comprises a plate fixed to the circuit board and two opposite hooks extending up from the plate, the hooks extend through the clamping portion.

4. The motherboard of claim 3, wherein a projection protrudes from an outer surface of each hook to be blocked by the clamping portion.

5. The motherboard of claim 4, the clamping portion is U-shaped and defining a open-ended slot therein for the hooks to extend through; the engaging portions are substantially U-shaped and respectively extend from opposite ends of the clamping portion at the opening of the slot.

6. The motherboard of claim 5, wherein each engaging portion comprises an extension portion extending from the corresponding end of the clamping portion, a connection portion extending from an end of the extension portion away from the clamping portion, and a pin extending inward from a distal end of the connection portion toward the other engaging portion to be inserted into a corresponding through hole.

7. A motherboard, comprising:
a circuit board comprising an electronic element and two latches positioned at opposite sides of the electronic element;
a heat sink comprising a base board attached to the electronic element, a plurality of rows of spaced fins extending up from the base board, and two rows of protrusions formed on the base board and positioned at opposite sides of a row of fins, each protrusion defining a through hole; and
two fixing members each comprising a clamping portion engaging with a corresponding one of the latches and two engaging portions engaging in the through holes of a corresponding one of the two lows of the through holes.

8. The motherboard of claim 7, wherein each clamping portion is substantially U-shaped to clamp the corresponding latch.

9. The motherboard of claim 8, wherein each latch comprises a plate fixed to the circuit board and two opposite hooks extending up from the plate, the hooks extend through the corresponding clamping portion.

10. The motherboard of claim 9, wherein a projection protrudes from an outer surface of each hook to be blocked by the corresponding clamping portion.

11. The motherboard of claim 10, each clamping portion is U-shaped and defining an open-ended slot therein for the corresponding hooks to extend through; the engaging portions of each fixing member are substantially U-shaped and respectively extend from opposite ends of the corresponding clamping portion at the opening of the slot.

12. The motherboard of claim 11, wherein each engaging portion comprises an extension portion extending from the corresponding end of the clamping portion, a connection portion extending from an end of the extension portion away from the clamping portion, and a pin extending inward from a distal end of the connection portion toward the other engaging portion to be inserted into a corresponding through hole.
